(19) United States
(12) Patent Application Publication
(10) Pub. No.: US 2024/0149401 A1
(43) Pub. Date: May 9, 2024

(54) CLAMP ASSEMBLY

(71) Applicant: Woodcraft Solutions LLC, Oregon City, OR (US)

(72) Inventor: Dwight Sheldon, Oregon City, OR (US)

(21) Appl. No.: 18/500,002

(22) Filed: Nov. 1, 2023

(30) Foreign Application Priority Data
Nov. 3, 2022 (TW) 111142070

(51) Int. Cl. B25B 5/16

(52) U.S. Cl. CPC B25B 5/16

(57) ABSTRACT

A clamp assembly has a positioning module, a rotating element, and a clamping module. The positioning module has a positioning component to be fixedly engaged with a first object for positioning and a shaft connected to the positioning component. The rotating element is rotatably sheathed onto the shaft. The clamping module is connected to a sleeve portion of the rotating element, is configured to slide upward or downward along the sleeve portion, and can secure a second object on a side of the first object along a clamping direction. A direction of the clamping module is quickly adjusted via rotations of the rotating element relative to the shaft. Thereby, when different clamping positions are nearby, clamping can be finished without readjusting the position of the clamp assembly, which improves flexibility and convenience of operating the clamp assembly.

### REFERENCE TO PRIOR APPLICATION

This application claims the benefit and priority of Taiwan patent application serial number TW 111142070 filed 3 Nov. 2022.

### BACKGROUND OF THE INVENTION

### 1. Field of the Invention

The present invention relates to a clamp assembly, and particularly to a clamp assembly that is rotatable to secure a second object at different positions on a first object.

### 2. Description of Related Art

A clamp is a tool to make two objects fixed with respect to each other for the convenience of subsequent operation. A conventional woodworking clamp has a positioning element and a clamping element. The positioning element is configured to position the conventional woodworking clamp onto a workbench, and the clamping element is disposed on the positioning element, is configured to slide upward or downward along the positioning element, and is capable of making a wood workpiece fixed on the workbench, which is convenient for processing the wood workpiece.

Further, the conventional woodworking clamp has two configurations. In the first configuration of the conventional woodworking clamp, the workbench has multiple sliding slots, and the positioning element is an L-shaped member having a horizontal portion and a vertical portion. The horizontal portion is configured to slide in one of the multiple sliding slots, and the vertical portion is configured for the clamping element to be connected. In the second configuration of the conventional woodworking clamp, the workbench has multiple positioning holes, and the positioning element is configured to be mounted and fixedly engaged with one of the multiple positioning holes.

However, the clamping element is disposed on a specific side of the positioning element to make the wood workpiece fixed. If the position of the wood workpiece has to be changed, the position of the positioning element on the workbench needs to be changed first to reposition the conventional woodworking clamp, and then the conventional woodworking clamp secures the wood workpiece once again by the clamping element. Thereby, if the initial position of the conventional woodworking clamp on the workbench does not satisfy the need of clamping the wood workpiece, the conventional woodworking clamp needs to be readjusted. The conventional woodworking clamp is thus inconvenient in operation.

To overcome the shortcomings of the conventional woodworking clamp, the present invention tends to provide a clamp assembly to mitigate or obviate the aforementioned problems.

### SUMMARY OF THE INVENTION

The main objective of the present invention is to provide a clamp assembly that has a positioning module and a clamping module being rotatable relative to the positioning module to improve flexibility and convenience in operation.

The clamp assembly is configured to secure a first object and a second object and has a positioning module, a rotating element, and a clamping module. The positioning module has a positioning component configured to be fixedly engaged with the first object for positioning and a shaft having a bottom end connected to the positioning component. The rotating element is rotatably sheathed onto the shaft and has a sleeve portion. The clamping module is connected to the rotating element and has an extending arm and a clamping element. The extending arm has two ends located away from each other. One of the two ends of the extending arm is mounted to the sleeve portion and configured to slide upward or downward along the sleeve portion, and the clamping element is connected to e other end of the extending arm away from the sleeve portion. The clamping element is configured to secure the second object on a side of the first object along a clamping direction.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a clamp assembly in accordance with the present invention;

FIG. 2 is an exploded perspective view of the clamp assembly in FIG. 1;

FIG. 3 is a side view in partial section of the clamp assembly in FIG. 1;

FIG. 4 depicts the clamp assembly in FIG. 1 being mounted on a workbench;

FIG. 5 is an operational view of the clamp assembly in FIG. 4;

FIG. 6 is an exploded perspective view of a second preferred embodiment of a clamp assembly in accordance with the present invention;

FIG. 7 depicts the clamp assembly in FIG. 6 being mounted on a workbench; and

FIG. 8 is a perspective view of a third preferred embodiment of a clamp assembly in accordance with the present invention.

### DETAILED DESCRIPTION OF THE PREFERRED EMBODIMENT

The present invention provides a clamp assembly configured to secure a first object and a second object. Specifically, the clamp assembly can be a woodworking clamp, and the first object and the second object can respectively be a workbench and a workpiece. For better comprehension, the first object and the second object are all described as the workbench and the workpiece respectively in the following statement.

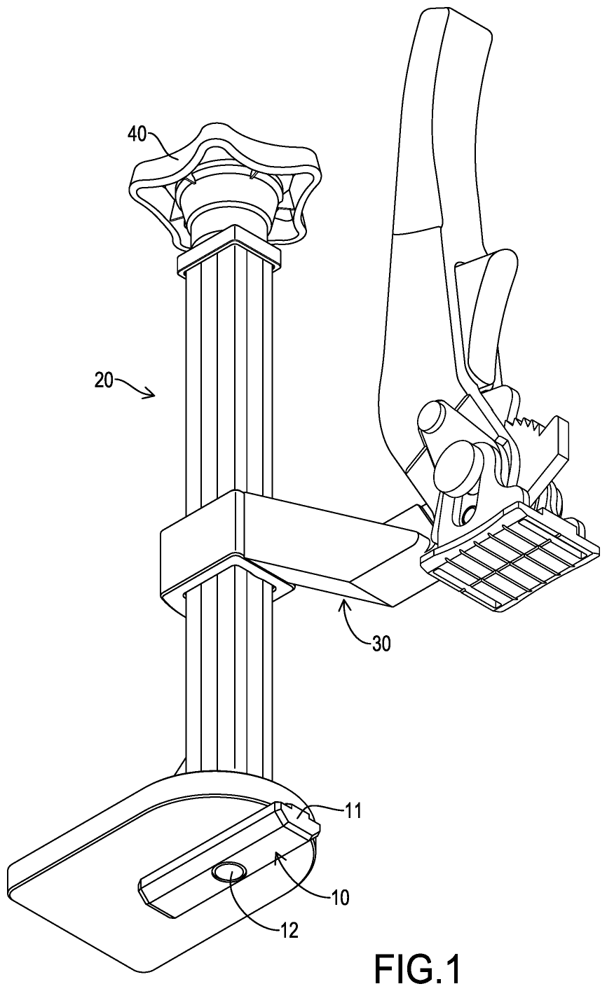

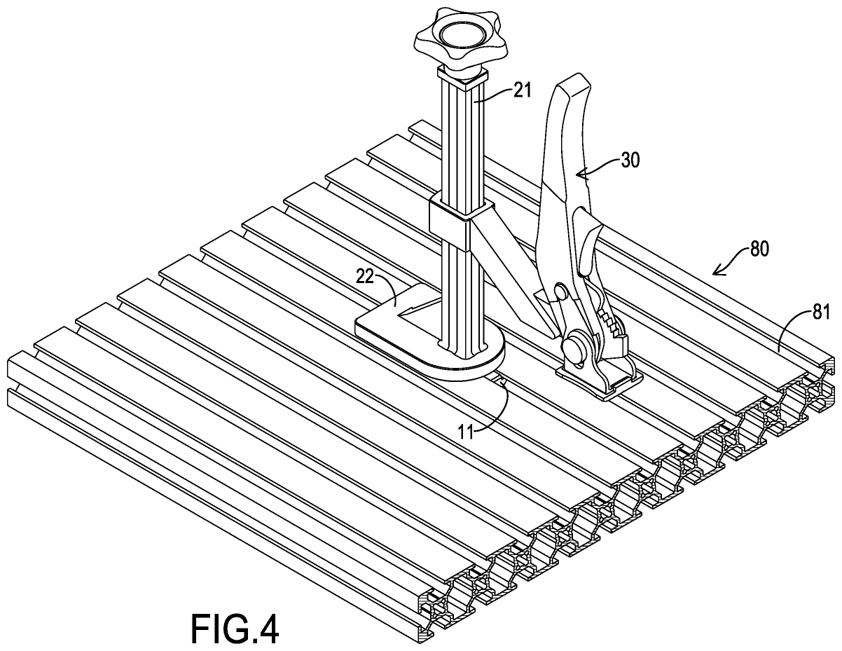

A first preferred embodiment of the clamp assembly in accordance with the present invention is shown in FIGS. 1 to 3, and 5. The clamp assembly is rotatable to secure the workpiece 90 at different positions on the workbench 80. With reference to FIGS. 1 to 4, the clamp assembly has a positioning module 10, a rotating element 20, a clamping module 30, and a knob 40. The positioning module 10 has a positioning component 11 and a shaft 12. The positioning component 11 is configured to be fixedly engaged with the workbench 80 for positioning. A bottom end of the shaft 12 is connected to the positioning component 11, and the shaft 12 extends along a direction being perpendicular to a surface of the workbench 80.

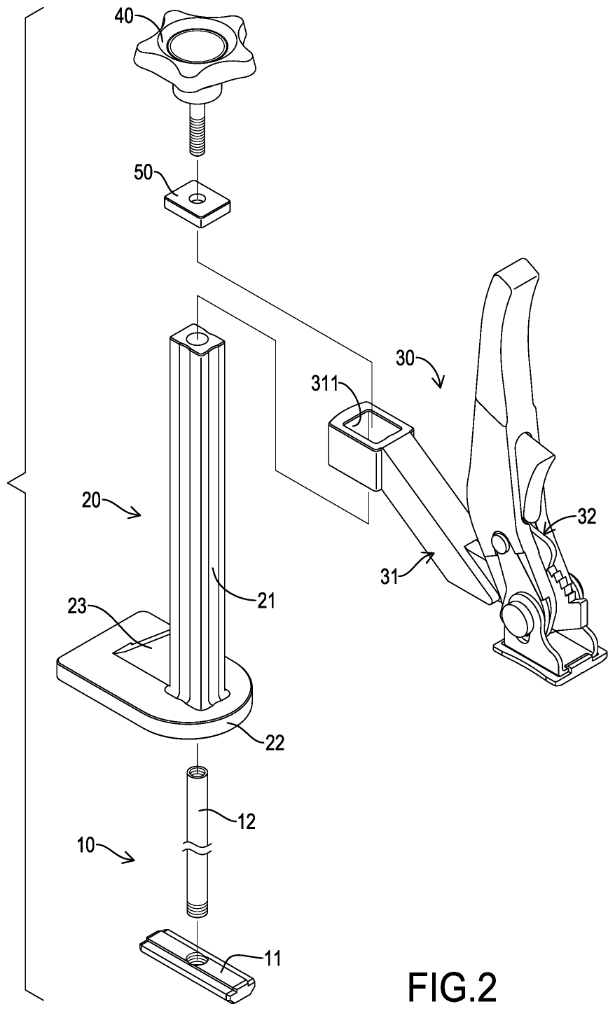

In the first preferred embodiment, the workbench 80 is an extrusion and has multiple T-slots 81. The multiple T-slots 81 are parallel to each other and are defined through two opposite sides of the workbench 80 which are defined along a horizontal direction. A top of each one of the T-slots 81 has an opening having a width smaller than that of a bottom of the T-slot 81. The positioning component 11 is a T-shaped nut and is capable of sliding in any one of the multiple T-slots 81. Moreover, the T-shaped nut can only enter or leave the T-slot 81 from two opposite ends of the T-slot 81 and cannot leave the T-slot 81 from the surface of the workbench 80. With reference to FIG. 2, the shaft 12 is threaded with the positioning component 11.

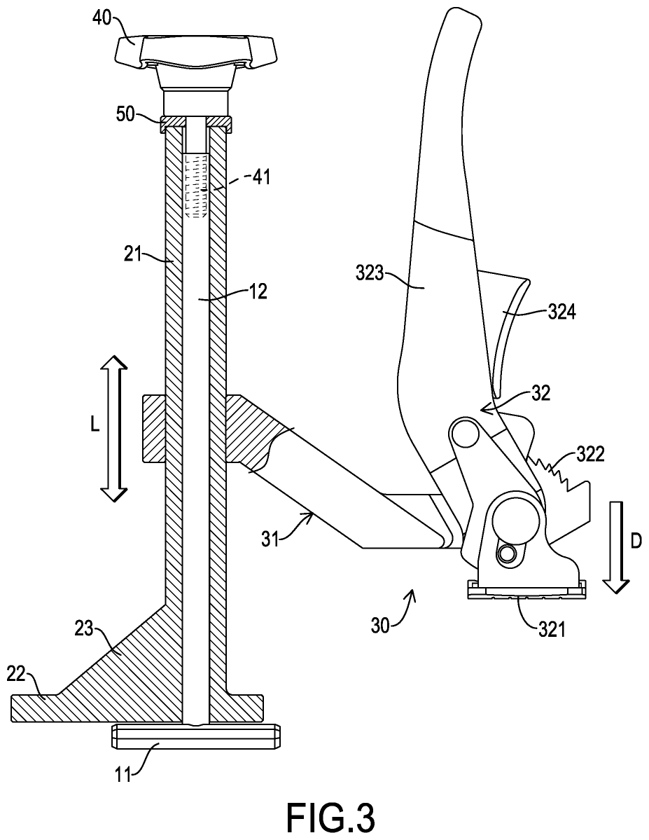

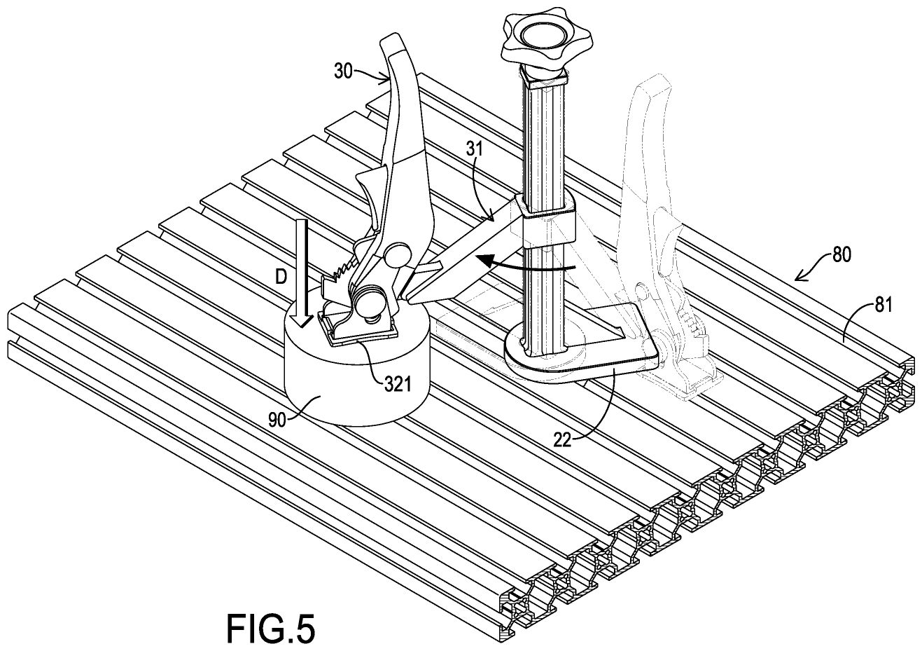

With reference to FIGS. 2, 3, and 5, the rotating element 20 is rotatably sheathed onto the shaft 12 and has a sleeve portion 21 having a height direction L. 15 The clamping module 30 is connected to the rotating element 20 and has an extending arm 31 and a clamping element 32. The extending arm 31 has two ends located away from each other. One of the two ends of the extending arm 31 is connected to the sleeve portion 21 and is configured to slide upward or downward along the height direction L, and the clamping element 32 is connected to the other one of the two ends of the extending arm 31 away from the sleeve portion 21. With reference to FIGS. 3 and 5, the clamping element 32 is capable of moving along a clamping direction D to secure the workpiece 90 on the workbench 80. In the first preferred embodiment, the clamping direction D and the height direction L are parallel to each other and are both perpendicular to the surface of the workbench 80.

Thus, in operation of the present invention, a user can quickly move the clamp assembly to an approximate position first, position the clamp assembly via the positioning module 10, and then make the rotating element 20 rotate relative to the shaft 12 to adjust a direction of the clamping module 30. Thereby, a position of the clamping element 32 on the workbench 80 can be flexibly and conveniently adjusted to secure the workpiece 90 appropriately. Therefore, when different clamping positions of the workpiece 90 are nearby, the user can finish clamping without readjusting the position of the clamp assembly, which improves flexibility and convenience of the clamp assembly.

Furthermore, in the first preferred embodiment, the extending arm 31 is non-rotatably connected to the sleeve portion 21. Since a reaction force acts on the clamping module 30 clamping the workpiece 90, the clamping element 32 is more likely to slip away from the workpiece 90 if the extending arm 31 is capable of not only sliding upward or downward but rotating relative to the sleeve portion 21. An angle of the clamping element 32 is adjusted with the configuration of the sleeve portion's 21 rotation relative to the shaft 12 of the positioning module 10 and the non-rotatable connection between the extending arm 31 and the sleeve portion 21, which not only improves the flexibility and convenience of operating the clamp assembly but also maintains sufficient stability of clamping the workpiece 90.

Specifically, the sleeve portion 21 has an exterior profile being noncircular, and a portion of the extending aim 31 is connected to the sleeve portion 21 and has an interior profile matching the exterior profile of the sleeve portion 21 to make the extending arm 31 non-rotatable relative to the sleeve portion 21. With reference to FIG. 2, the sleeve portion 21 has the exterior profile being substantially rectangular, and the extending arm 31 has a rectangular connecting hole 311 for the extending arm 31 to be sheathed onto the sleeve portion 21. In other embodiments, the exterior profile of the sleeve portion 21 may be other noncircular shapes as long as the extending arm 31 is non-rotatable relative to the sleeve portion 21.

Moreover, to prevent the sleeve portion 21 of the rotating element 20 or the shaft 12 of the positioning module 10 from bearing an excessive bending moment, the rotating element 20 has a supporting base 22 and a strengthening structure 23. The supporting base 22 radially extends from a bottom end of the sleeve portion 21, is formed in one piece with the sleeve portion 21, and is adapted to abut against the surface of the workbench 80; the extending arm 31 of the clamping module 30 and the supporting base 22 respectively extend relative to the sleeve portion 21 along two opposite directions. Thus, a normal force provided by the workbench 80 to the supporting base 22 prevents the sleeve portion 21 or the shaft 12 from deformation due to the excessive bending moment. The strengthening structure 23 is formed between and formed in one piece with the sleeve portion 21 and the supporting base 22, which improves the supporting effect of the normal force described above.

With reference to FIGS. 2 and 3, the knob 40 is rotatably disposed on a top end of the sleeve portion 21 and connected to the shaft 12 of the positioning module 10 via threads 41. Thereby, when the knob 40 is turned, the shaft 12 moves upward relative to the sleeve portion 21 due to the threads 41. The positioning component 11 (the T-shaped nut) is actuated by the shaft 12 to move upward and be fixedly engaged with one of the multiple T-slots 81 of the workbench 80, and the positioning of the clamp assembly is finished. In addition, in the first preferred embodiment, the clamp assembly has a gasket 50 disposed on the top end of the sleeve portion 21. The knob 40 is located through the gasket 50, extends into an interior of the sleeve portion 21, and is connected to the shaft 12.

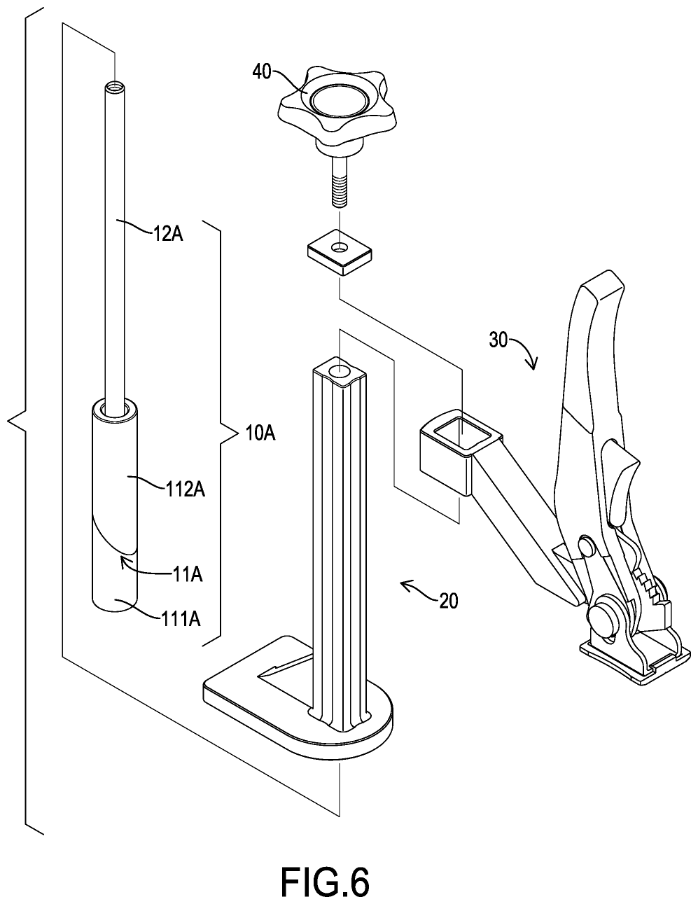

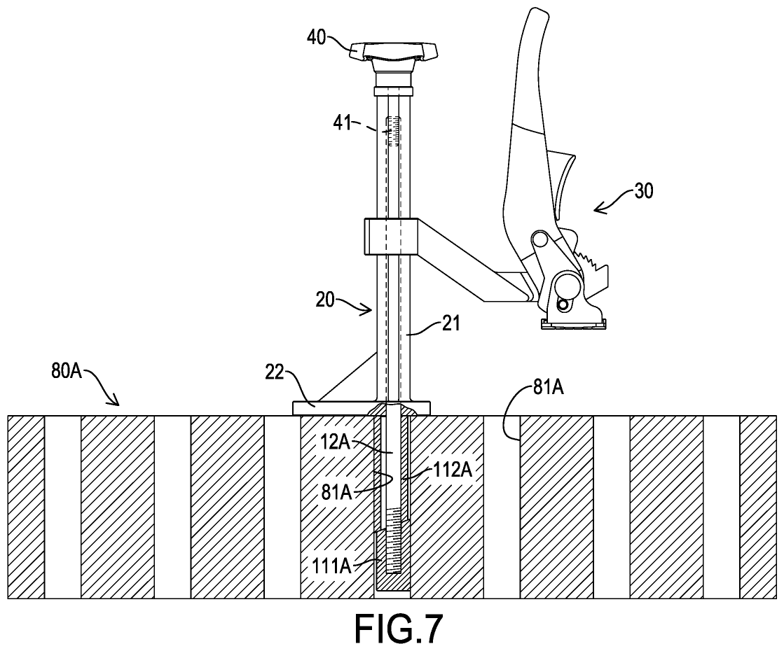

With reference to FIGS. 6 and 7, a second preferred embodiment of the clamp assembly in accordance with the present invention is shown, and differences between the second preferred embodiment and the first preferred embodiment are described below. In the second preferred embodiment, the workbench 80A has multiple circular positioning holes 81A, and the positioning component 11A of the positioning module 10 has a first positioning block 111A and a second positioning block 112A. With reference to FIG. 7, the first positioning block 111A is threaded with the shaft 12A and has a wedge surface facing upward. The second positioning block 112A is sheathed onto the shaft, is disposed between the supporting base 22 of the rotating element 20 and the first positioning block 111A, and has a wedge surface facing downward. The wedge surface of the first positioning block 111A and the wedge surface of the second positioning block 112A abut against each other, and the second positioning block 112A has an inner diameter being larger than an outer diameter of the shaft 12A.

When the shaft 12A is actuated to move upward by turning the knob 40, the first positioning block 111A moves upward along with the shaft 12A, and the second positioning block 112A is limited between the supporting base 22 on the bottom of the rotating element 20 and the first positioning block 111A and thus cannot move upward. Thereby, the first positioning block 111A and the second positioning block 112A relatively slide along the wedge surfaces thereof, which makes the first positioning block 111A and the second positioning block 112A expand along radial directions of the shaft 12A and be fixedly engaged with one of the multiple positioning holes 81A of the workbench 80.

With the configuration of the positioning component 11, 11A connected to the shaft 12, 12A via threads as described above, the rotatable clamp assembly of the present invention can be applied on different types of the workbenches 80, 80A by easily changing types of the positioning component 11, 11A which is connected to the shaft 12, 12A.

In the first and second preferred embodiments, with reference to FIG. 3, the clamping element 32 is a ratchet clamp and has a clamping block 321, a ratchet toothed portion 322, a pawl handle 323, and an unlocking element 324. The clamping block 321 is pivotally connected to the end of the extending aim 31 located away from the sleeve portion 21 and has a clamping surface facing downward. The clamping surface of the clamping block 321 is able to keep facing downward due to the gravity. The ratchet toothed portion 322 is located on one of the two ends of the extending arm 31 away from the sleeve portion 21 and has multiple ratchet teeth. The pawl handle 323 is swingably connected to one of the two ends of the extending arm 31 away from the sleeve portion 21 and is configured to engage with a part of the multiple ratchet teeth of the ratchet toothed portion 322.

When the pawl handle 323 is fastened and locked with the ratchet toothed portion 322, the clamping module 30 is thus fixed with respect to the rotating element 20 via the above-mentioned locking action and thus secures the workpiece 90 on the workbench 80 via the clamping element 32. The unlocking element 324 is connected to the pawl handle 323 and is pressable for releasing the pawl handle 323 from the ratchet toothed portion 322. The detailed construction and operating principles of the ratchet clamp is conventional and is thus not described in detail here.

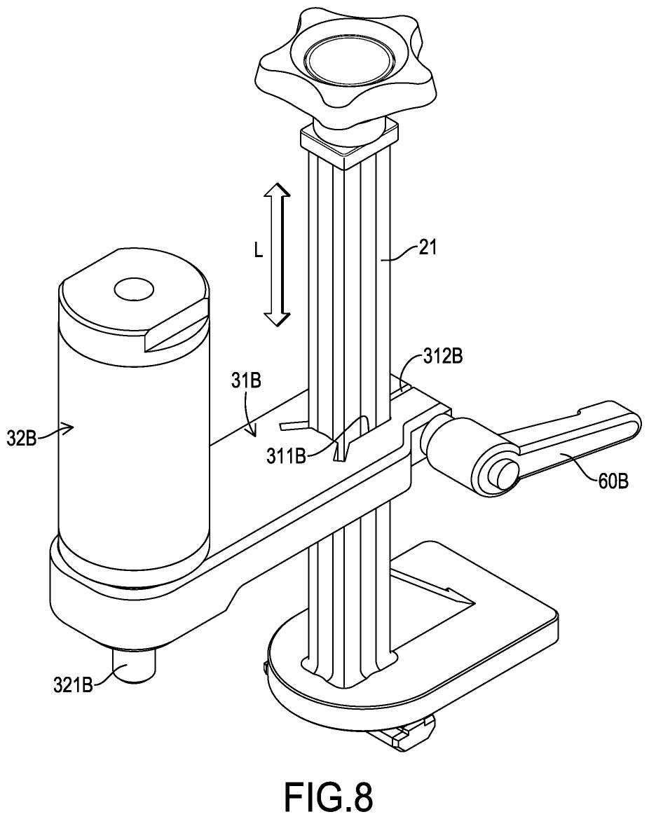

With reference to FIG. 8, a third preferred embodiment of the clamp assembly in accordance with the present invention is shown, and differences between the third preferred embodiment and the first preferred embodiment are described below. In the third preferred embodiment, the extending aim 31B has a groove 312B communicating with the connecting hole 311B and an external space of the extending arm 31B. The clamp assembly has a quick-release component 60B, and the quick-release component 60B is mounted through the extending arm 31B and is located through two opposite sides of the groove 312B to be configured to make the extending arm 31B fixed on a specific position along the height direction L of the sleeve portion 21. The clamping element 32 is a pneumatic clamp and has a piston rod 321B for clamping the workpiece 90.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clamp assembly configured to secure a first object and a second object, the clamp assembly comprising:
a positioning module having
a positioning component configured to be fixedly engaged with the first object for positioning; and
a shaft having a bottom end connected to the positioning component;
a rotating element rotatably sheathed onto the shaft and having a sleeve portion; and
a clamping module connected to the rotating element and having
an extending arm having
two ends located away from each other, and one of the two ends mounted to the sleeve portion and configured to slide upward or downward along the sleeve portion; and
a clamping element connected to the other one of the two ends of the extending arm away from the sleeve portion;
wherein the clamping element is configured to secure the second object on a side of the first object along a clamping direction.

2. The clamp assembly as claimed in claim 1, wherein the extending aim is non-rotatably connected to the sleeve portion.

3. The clamp assembly as claimed in claim 2, wherein
the sleeve portion has an exterior profile being noncircular; and
a portion of the extending arm which is connected to the sleeve portion has an interior profile matching the exterior profile of the sleeve portion to make the extending arm non-rotatable relative to the sleeve portion.

4. The clamp assembly as claimed in claim 1, wherein
the rotating element has a supporting base;
the supporting base extends from a bottom end of the sleeve portion along a radial direction of the sleeve portion, is formed in one piece with the sleeve portion, and is adapted to abut against the first object; and
the extending arm of the clamping module and the supporting base respectively extend relative to the sleeve portion along two opposite directions.

5. The clamp assembly as claimed in claim 1, wherein the clamping element is a ratchet clamp or a pneumatic clamp.

6. The clamp assembly as claimed in claim 1, wherein the clamp assembly has a knob rotatably disposed on a top end of the sleeve portion and connected to the shaft of the positioning module via threads; whereby when the knob is turned, the positioning component is actuated by the shaft to move upward relative to the sleeve portion and be fixedly engaged with a containing structure of the first object.

7. The clamp assembly as claimed in claim 2, wherein the clamp assembly has a knob rotatably disposed on a top end of the sleeve portion and connected to the shaft of the positioning module via threads; whereby when the knob is turned, the positioning component is actuated by the shaft to move upward relative to the sleeve portion and be fixedly engaged with a containing structure of the first object.

8. The clamp assembly as claimed in claim 3, wherein the clamp assembly has a knob rotatably disposed on a top end of the sleeve portion and connected to the shaft of the positioning module via threads; whereby when the knob is turned, the positioning component is actuated by the shaft to move upward relative to the sleeve portion and be fixedly engaged with a containing structure of the first object.

9. The clamp assembly as claimed in claim 4, wherein the clamp assembly has a knob rotatably disposed on a top end of the sleeve portion and connected to the shaft of the positioning module via threads; whereby when the knob is turned, the positioning component is actuated by the shaft to move upward relative to the sleeve portion and be fixedly engaged with a containing structure of the first object.

10. The clamp assembly as claimed in claim 5, wherein the clamp assembly has a knob rotatably disposed on a top end of the sleeve portion and connected to the shaft of the positioning module via threads; whereby when the knob is turned, the positioning component is actuated by the shaft to move upward relative to the sleeve portion and be fixedly engaged with a containing structure of the first object.

11. The clamp assembly as claimed in claim 6, wherein
the positioning component is a T-shaped nut and is threaded with the shaft;
the containing structure of the first object where the positioning component is fixedly engaged is a T-slot; and
when the positioning component moves upward along with the shaft, the T-shaped nut is fixedly engaged with the T-slot.

12. The clamp assembly as claimed in claim 7, wherein
the positioning component is a T-shaped nut and is threaded with the shaft;
the containing structure of the first object where the positioning component is fixedly engaged is a T-slot; and
when the positioning component moves upward along with the shaft, the T-shaped nut is fixedly engaged with the T-slot.

13. The clamp assembly as claimed in claim 8, wherein
the positioning component is a T-shaped nut and is threaded with the shaft;
the containing structure of the first object where the positioning component is fixedly engaged is a T-slot; and
when the positioning component moves upward along with the shaft, the T-shaped nut is fixedly engaged with the T-slot.

14. The clamp assembly as claimed in claim 9, wherein
the positioning component is a T-shaped nut and is threaded with the shaft;
the containing structure of the first object where the positioning component is fixedly engaged is a T-slot; and
when the positioning component moves upward along with the shaft, the T-shaped nut is fixedly engaged with the T-slot.

15. The clamp assembly as claimed in claim 10, wherein
the positioning component is a T-shaped nut and is threaded with the shaft;
the containing structure of the first object where the positioning component is fixedly engaged is a T-slot; and
when the positioning component moves upward along with the shaft, the T-shaped nut is fixedly engaged with the T-slot.

16. The clamp assembly as claimed in claim 6, wherein
the positioning component has a first positioning block and a second positioning block;
the first positioning block is threaded with the shaft and has a wedge surface facing upward;
the second positioning block is sheathed onto the shaft, is disposed between the rotating element and the first positioning block, and has a wedge surface facing downward;
the containing structure of the first object where the positioning component is fixedly engaged is a circular positioning hole; and
when the positioning component moves upward along with the shaft, the first positioning block and the second positioning block expand along radial directions of the shaft and are fixedly engaged with the circular positioning hole.

17. The clamp assembly as claimed in claim 7, wherein
the positioning component has a first positioning block and a second positioning block;
the first positioning block is threaded with the shaft and has a wedge surface facing upward;
the second positioning block is sheathed onto the shaft, is disposed between the rotating element and the first positioning block, and has a wedge surface facing downward;
the containing structure of the first object where the positioning component is fixedly engaged is a circular positioning hole; and
when the positioning component moves upward along with the shaft, the first positioning block and the second positioning block expand along radial directions of the shaft and are fixedly engaged with the circular positioning hole.

18. The clamp assembly as claimed in claim 8, wherein
the positioning component has a first positioning block and a second positioning block;
the first positioning block is threaded with the shaft and has a wedge surface facing upward;
the second positioning block is sheathed onto the shaft, is disposed between the rotating element and the first positioning block, and has a wedge surface facing downward;
the containing structure of the first object where the positioning component is fixedly engaged is a circular positioning hole; and
when the positioning component moves upward along with the shaft, the first positioning block and the second positioning block expand along radial directions of the shaft and are fixedly engaged with the circular positioning hole.

19. The clamp assembly as claimed in claim 9, wherein
the positioning component has a first positioning block and a second positioning block;
the first positioning block is threaded with the shaft and has a wedge surface facing upward;
the second positioning block is sheathed onto the shaft, is disposed between the rotating element and the first positioning block, and has a wedge surface facing downward;
the containing structure of the first object where the positioning component is fixedly engaged is a circular positioning hole; and
when the positioning component moves upward along with the shaft, the first positioning block and the second positioning block expand along radial directions of the shaft and are fixedly engaged with the circular positioning hole.

20. The clamp assembly as claimed in claim 10, wherein
the positioning component has a first positioning block and a second positioning block;
the first positioning block is threaded with the shaft and has a wedge surface facing upward;
the second positioning block is sheathed onto the shaft, is disposed between the rotating element and the first positioning block, and has a wedge surface facing downward;
the containing structure of the first object where the positioning component is fixedly engaged is a circular positioning hole; and
when the positioning component moves upward along with the shaft, the first positioning block and the second positioning block expand along radial directions of the shaft and are fixedly engaged with the circular positioning hole.
